(19) United States
(12) Patent Application Publication
(10) Pub. No.: US 2023/0148791 A1
(43) Pub. Date: May 18, 2023

(54) SYSTEM AND METHOD FOR A FOOD PREPARATION

(71) Applicant: Vorwerk & Co. Interholding GmbH, Wuppertal (DE)

(72) Inventors: Matthias Stein, Mülheim an der Ruhr (DE); Ingo Dering, Wermelskirchen (DE)

(21) Appl. No.: 17/980,966

(22) Filed: Nov. 4, 2022

(30) Foreign Application Priority Data
Nov. 15, 2021 (EP) 2120-8127.7
Nov. 15, 2021 (EP) 21208127.7

(51) Int. Cl. A47J 36/32

(52) U.S. Cl. CPC A47J 36/321; A47J 2202/00

(57) ABSTRACT

The present disclosure relates to a system for the preparation of a food. The system comprises a monitoring device for monitoring the food during its preparation, a control device for the preparation of the food by means of a kitchen appliance and by means of an electronically stored recipe, and a mobile and/or non-mobile device. The monitoring device is able to communicate with the control device and the mobile and/or non-mobile device. The mobile and/or non-mobile device is configured such that it can transmit information of the monitoring device to a user. In particular, the control device is configured such that it recognizes possible absence times for a user during the controlled preparation of a food and informs the user thereof. The invention further relates to a food thermometer and a method.

### CROSS-REFERENCE TO RELATED APPLICATION

This application claims priority to European Application No. 21208127.7, filed Nov. 15, 2021, which application is hereby incorporated in its entirety herein.

### FIELD OF THE DISCLOSURE

The present disclosure relates to a system for the preparation of a food. The system comprises a monitoring device for the preparation of the food by a kitchen appliance and a control device for the preparation of food by means of an electronically stored recipe. The system comprises a mobile device.

The disclosure further relates to a food thermometer and a method.

### BACKGROUND

When a food is produced from foodstuffs, many processing steps must initially be carried out commonly one after the other in a timely manner. For the preparation of chops, for example, it may be necessary to peel and chop garlic, wash and chop herbs, mix chopped herbs together with the chopped garlic, spices and oil. Then the chops should be placed in the marinade prepared in this way. Once this has been done, a resting period of, for example, 60 minutes may then be provided to allow the marinade to take effect. Following this, the chops are to be heated on a grill, for example. Further processing steps must therefore be performed.

So, in the preparation of a food, there are periods of time that require activities of a human being and thus his presence. There may also be periods that do not require human activity. The human being can then be absent, i.e., he or she does not have to be in the vicinity of the chops. In the following, this human is called “user”.

To relieve a user during the preparation of a food, there are kitchen appliances such as food processors with food preparation vessels and heating devices. Food processors can increase the degree of automation during the preparation of a food. For example, a control device of a food processor can temperature control the food preparation vessel of the food processor in an automated manner. It is then not necessary for a user to monitor and, if necessary, intervene to avoid temperatures that are too high or too low. A user can then be absent when there are no other processing steps to be performed manually. An increased degree of automation therefore allows longer absence times.

To facilitate a user’s absence, a food processor may comprise a timer and a speaker. For example, the timer can be used to set the time required for temperature control of a food manually or in an automated manner. When the timer has expired, an acoustic signal indicates to the user that the end of a cooking time has been reached. A user may then be absent. However, he or she must be within earshot to hear the signal.

It is the task of the present disclosure to relieve a user who wants to prepare a food.

### SUMMARY

To solve the task of relieving a user during food preparation, a system comprises the features of claim 1. In addition a method comprises the features of the additional claim(s). Advantageous embodiments comprise the features of the dependent claims.

According to the present disclosure, a system for the preparation of a food with a monitoring device for monitoring the food is provided. The system comprises a control device for the preparation of the food by means of a kitchen appliance and by means of an electronically stored recipe. The system comprises a device, in particular a mobile device. The system may also comprise both the mobile device and the non-mobile device. The monitoring device is able to communicate with the control device and the preferably mobile device. The preferably mobile device is able to transmit information of the monitoring device to a user.

The system makes it possible to prepare food with a high degree of automation. The higher a degree of automation, the less the need for a user to be present during the preparation of a food. To maximize the time periods that allow a user’s absence, the system comprises the mobile device. Through the mobile device, even an absent user can learn about the condition of a food preparation. The user can thus assess in an improved manner when his presence is required again during the preparation of a food. Thus, designs in accordance with the present disclosure can facilitate an absence. In particular, a user does not have to be within earshot.

### BRIEF DESCRIPTIONS OF THE DRAWINGS

The present disclosure is explained in more detail below with reference to figures.

They show

FIG. 1: pen-shaped food thermometer during a food preparation in a kitchen appliance;

FIG. 2: food processor;

FIG. 3: mobile device;

FIG. 4: system with connection between food processor and monitoring device;

FIG. 5: system with monitoring device transmitting to multiple devices;

FIG. 6: system with connection between mobile device and monitoring device;

FIG. 7: system with monitoring device transmitting to multiple devices;

FIG. 8: system of a second configuration with connection between food processor and monitoring device.

### DETAILED DESCRIPTION

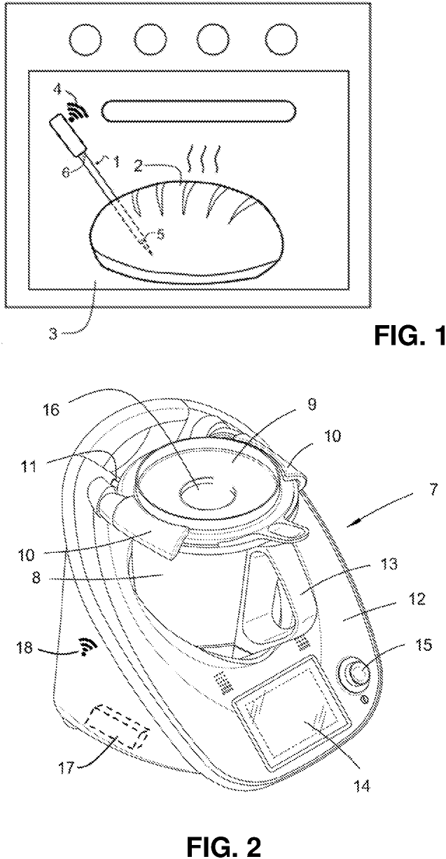

FIG. 1 shows a monitoring device. The monitoring device is a pen-shaped food thermometer 1, the tip of which is inserted into a bread dough 2. The bread dough 2 is placed in a kitchen appliance. The kitchen appliance is an oven 3. The bread dough 2 is heated in the oven 3. The food thermometer 1 determines temperatures in the oven in a spatially resolved manner, which are determined by means of two temperature sensors 5 and 6 both outside the bread dough and inside the bread dough. These determined temperatures are transmitted by a radio unit 4 to an external control device or to a mobile device. The bread preparation is controlled by the control device. This can be done by directly control of the temperature of the oven 3 or by instructing a user how to change the temperature of the oven, the type of temperature supply and/or the arrangement of the bread within the oven. Type of temperature supply means choices such as top heat, bottom heat, or convection. Arrangement means where in the oven 3 the bread dough 2 is to be located. By the mobile device at least the determined temperatures can be displayed and, thus, monitored.

FIG. 2 shows a food processor 7 with a food preparation vessel 8. A lid part 9 is placed on the food preparation vessel 8. The lid part 9 for the food preparation vessel 8 is locked by arm-like locking elements, i.e. arms 10. The lid part 9 is located between the two arms 10. The arms 10 can be rotated around their longitudinal axis in a motorized manner and thus back and forth between an open position and a locked position. The lid part 9 has pressed down and, thus, triggered a sensor, namely a rocker arm 11 of an electric switch. The arm-like locking members 10 and the rocker arm 11 are attached to a stand part 12 of the food processor 7. The food preparation vessel 8 is inserted into the stand part 12 and can be removed from the stand part 12. In order to be able to remove the food preparation vessel 8, this comprises a handle 13. For operation, the stand part 12 comprises a touch-sensitive display 14 and a rotary switch 15. The rotary switch 15 can be rotated and pressed. Display 14 and rotary switch 15 are thus control elements of the food processor 7. The lid part 9 comprises an opening 16 in the center, which can be closed with a vessel-like closure.

A control device 17 is located in the stand part 12. Data can be entered into the control device via the control elements 14 and 15. A radio unit 18 by means of which data can transmitted and received wirelessly is located in the stand part 12. The control device 17 can access an externally stored recipe via the radio unit 18. Subsequently, the control device 17 can control the preparation of a food by means of the recipe. Via the radio unit 18, the control device 17 can exchange data wirelessly with the food thermometer 1, i.e. communicate.

A cutting tool that can be driven by a motor is located in the food preparation vessel 8. The motor is located in the stand part 12. A heating device is provided in the base of the food preparation vessel 8, which can be electrically connected to the stand part 12 for heating.

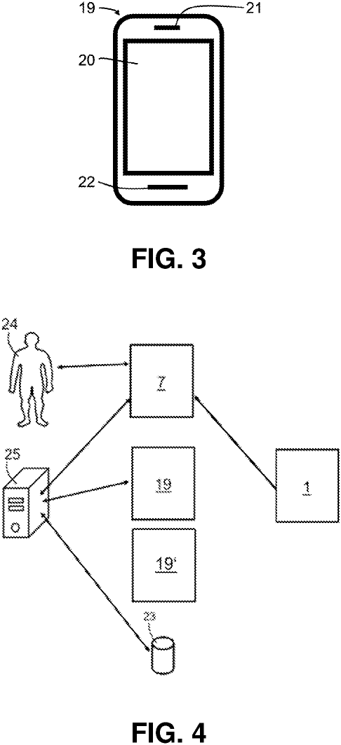

FIG. 3 shows a mobile device. The mobile device is a smartphone 19. The smartphone 19 comprises a touch-sensitive display 20, a speaker 21 and a microphone 22. The smartphone comprises a radio unit. Via the radio unit, the smartphone 19 can exchange data with the thermometer 1. The radio unit may comprise, among other things, Wi-Fi, Bluetooth Low Energy and/or Ultra Wideband (UWB) as a standard.

FIG. 4 shows the system according to the invention. The system comprises a speaker assistant 23. A user 24 and an external computer 25 are shown. The food processor 7 is connected to the computer 25, for example via the Internet, in such a way that data can be exchanged between the computer 25 and the food processor 7. Recipes are stored electronically on the computer. The user 24 can view the recipes on the display of the food processor and select a recipe. Alternatively or additionally, recipes can be stored in a memory of the food processor 7.

A program may be installed on the first smartphone 19 that can also establish or has established a connection to the computer 25 as indicated by the double arrow. The first smartphone 19 may be a smartphone of the user 24. A recipe may therefore also be selected by the user 24 via the first smartphone 19. The first smartphone is part of the system according to the invention.

Furthermore, the speaker assistant 23 may be connected to the computer 25. For example, a recipe may then be selected by the user 24. The selection may be done by speech recognition, for example.

The thermometer 1 is exclusively connected to the food processor 7 in such a way that the control device of the food processor 7 can exchange data with the thermometer 1. The exchange of data is such that this contributes to the control of the preparation of a food. The thermometer 1 cannot transmit data to other devices in such a way that another device can contribute data to a preparation of a food. In particular, no connection can be established between the thermometer 1 and another device that would allow an exchange of data such that this can contribute to the preparation of a food.

By means of a status indicator it can be achieved that the control device of the food processor 7 is exclusively connected to the food thermometer 1 and no further connection can be established. Status indicators are also called “flags”. For example, there may be a status indicator on the electronics of the food thermometer 1 that is set so that the food thermometer 1 is not free for other connections. A further status indicator may be present and set such that the food thermometer is not free for control.

The thermometer 1 can transmit to the control device of the food processor 7 determined temperatures or at least a measure for determined temperatures. The thermometer 1 may transmit to the food processor 7 determined manufacturer information so that the control device 1 knows how to interpret and evaluate received data.

The data transmitted from the thermometer 1 to the control device of the food processor 7 may include a Universally Unique Identifier (UUID) and/or a name. The name may have been selected by the user 24, for example, to easily identify the thermometer 1.

There may be a second smartphone 19′. This is not connected to any other device and cannot be connected to any other device if no suitable program is installed and invoked on the second smartphone 19′. This second smartphone 19′ is therefore then not part of the system according to the invention. This does not exclude that the second smartphone 19′ can become part of the system.

For example, as indicated by FIG. 1, a bread is prepared by means of a recipe and controlled by the control device of the food processor 7. After the bread dough 2 has been prepared and placed in the oven 3 as shown in FIG. 1, it is finally noted in the recipe that the control device of the food processor 7 is no longer required. Subsequently, the control device of the food processor 7 defines useful data which the thermometer will send in the future. This useful data is also called “payload”. In addition, the control device of the food processor 7 defines, for example, that the food thermometer 1 can send the useful data and thus data to other devices in such a way that other devices can receive the data in such a way that they can be used by other devices. For example, if another device is capable of at least partially displaying the data, for example on a display, or acoustically outputting the data then another device can use the data. In the case of the food thermometer 1, the data include in particular temperatures that are determined by the food thermometer 1.

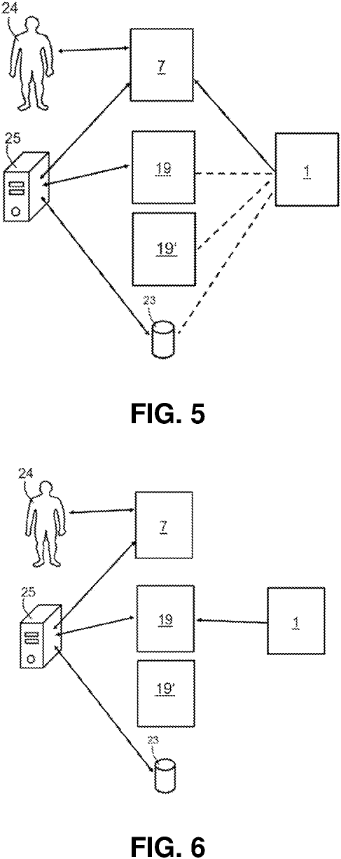

Subsequently, the food thermometer 1 also sends data to other devices as indicated by dashed lines in FIG. 5. It may be that other devices can then receive the data at least in part so that they can output useful data optically and/or acoustically. It may be that sending data only enables another device to establish an exclusive connection to the control device of the food processor 7. There may still be a connection between the control device of the food processor 7 and the food thermometer 7 that allows communication such that, for example, useful data is modified once again. However, it is also possible that this connection has been interrupted.

Another device, for example the first smartphone 19 as shown in FIG. 6, now produces a connection exclusively to the control device of the food processor 7, for example. No data is then transmitted to any other devices, which can be received and used by other devices. In particular, there is now also no connection between the control device of the food processor 7 and the food thermometer 1. The first smartphone 19 now receives from the food thermometer 1 at least the useful data that have been defined by the control of the food processor 7. The connection between the food thermometer 1 and the first smartphone 19 may have been made by a program that has been installed and invoked on the first smartphone 19. The connection may have comprised the input of a letter and/or number combination, i.e. a key, previously output acoustically and/or optically by the food processor 7.

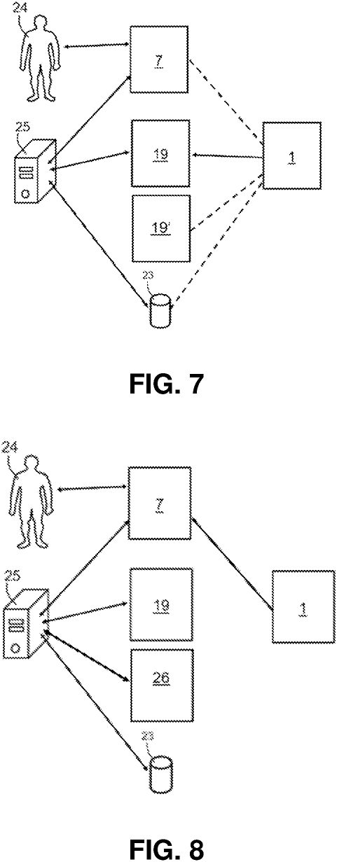

It may also be possible for the user 24 to set on the first smartphone 19 that data, in particular useful data, is transmitted to other devices in such a way that other devices can read and output transmitted data at least in part. This situation is illustrated in FIG. 7. It may also be possible for the user 24 to set on the first smartphone 19 that data is transmitted to other devices in such a way that another device can produce an exclusive connection. For example, if required, an exclusive connection could again be produced between the control of the food processor 7 and the food thermometer 1.

In FIG. 8, a system is shown that shows a second control device 26. The second control device 26 may be intended and suitable to take over control from the first control device 17 when the first control device is switched off, for example. The first control device may then be part of a food processor that is turned off. The second control device may then be part of another non-mobile kitchen appliance.

Food is produced from foodstuffs. For the preparation of a food, one or more foodstuffs are processed. Processing may comprise mechanical processing of foodstuffs, such as mixing, stirring and/or chopping foodstuffs. Processing may comprise applying heat. For example, heat may be applied to meat, vegetables, casseroles, or dough for baked goods to produce or contribute to producing a food.

The kitchen appliance is a stationary device, which is placed for example in a kitchen for the preparation of a food. The kitchen appliance is an appliance that can and should contribute to the preparation of a food. The kitchen appliance basically comprises a vessel or a space in which a food can be prepared. The kitchen appliance may comprise a tool that can be used to process foodstuffs. The tool may be a mixing tool and/or a cutting tool for stirring, mixing, and/or chopping foodstuffs. The kitchen appliance may comprise a tempering device for tempering foodstuffs for preparing a food. Temperature control (tempering) may comprise heating or cooling. The kitchen appliance may comprise a steam generating device for processing foodstuffs by means of steam.

The monitoring device comprises one or more detectors by means of which the preparation of a food can be monitored. For example, a detector may be a temperature sensor, an optical sensor, a humidity sensor, or a weight sensor. The monitoring device monitors one or more conditions that exist in the food or in the surroundings of the food. For example, the monitoring device may monitor temperatures, optical conditions, humidity, or weight during the preparation of a food. The monitoring device may be a camera, for example, which can be used to optically monitor the food during preparation.

The control device can control the preparation of a food by means of an electronically stored recipe. The control device may be a computer that is programmed and configured such that it can control the preparation of a food. The recipe may be stored in a memory of the control device. The recipe may be stored in an external memory. The control device may be configured such that it can access the externally stored recipe, for example, via the Internet.

A recipe comprises a plurality of steps for processing foodstuffs for a food. For example, one step may be to weigh 500 g of potatoes. Another step may be to peel the 500 g of potatoes by means of the kitchen appliance. Another step may be to put the peeled potatoes into a baking vessel along with other ingredients such as spices, cream and cheese. A further step may consist of preheating an oven. A further step may consist of placing the baking vessel with the potatoes and other ingredients in the preheated oven. A further step may consist of applying heat to the baking vessel with the potatoes and other ingredients in the oven for 30 minutes. The recipe also illustrates that the preparation of a food may require several different kitchen appliances.

The control device can control the performance of the steps. For example, the control device may output an action instruction to a user acoustically via a speaker and/or optically via a screen for control. The action instruction may be to weigh 500 g of potatoes in a vessel of a kitchen appliance that can weigh and peel potatoes. The speaker and/or the screen may be part of the control device. The control device may, for example, control the peeling of the potatoes by the control device setting a rotational speed and a rotation duration of the peeling tool of the kitchen appliance in an automated manner and/or stopping the peeling tool in an automated manner when the end of the peeling duration is reached. The control device can also control, for example, another kitchen appliance such as the temperature in the aforementioned oven.

The monitoring device can communicate with the control device. The communication may comprise transmitting detected values from the monitoring device to the control device. The communication may be wireless.

The mobile device is intended and suitable to be carried by a user or at least to be placed at a freely selectable location. Thus, as a rule, the mobile device is not placed in a kitchen where the kitchen appliance for the food is located. A cell phone, such as a smartphone, is one example of a mobile device. Another example of a mobile device is an assistant speaker that allows voice control.

A mobile device usually comprises an integrated power supply. The integrated power supply may be a battery. The integrated power supply allows the mobile device to be electrically operated independent of location.

The monitoring device can communicate with the preferably mobile device. The communication may comprise transmitting detected values from the monitoring device to the control device. The communication may comprise transmitting manufacturer information from the monitoring device to the control device. The communication between the preferably mobile device and the monitoring device is preferably wireless. Conversely, the communication may comprise the control device controlling the start and/or end of measurements and of sending measured values by the monitoring device.

A mobile device comprises an output device for outputting a condition detected by the monitoring device and transmitted to the mobile device. The output device may be a speaker or an optical signal device. The optical signal device may comprise, for example, one or more light emitting diodes. The optical signal device may be a display.

The control device may be configured such that it can recognize possible absence times for a user during the controlled preparation of a food and inform the user thereof. Absence possibilities can be used in an improved manner. A user is thus further relieved in an improved manner.

Controlled preparation means that the preparation is performed by means of an electronically stored recipe. A processing step of a recipe may comprise information whether a user is required for the processing or not. A processing step of a recipe may comprise information on how much time is required to perform the processing step. The control device may evaluate this information and thus recognize when the presence of a user is not required for the preparation of the food. The control device may calculate how long a user can be absent based on this information. For example, the control device can inform a user that he or she may be absent as soon as the period of possible absence exceeds a predetermined threshold.

For example, the preparation of a food comprises, on the one hand, cooking a rack of lamb for 40 minutes in an oven at a temperature of 160° C. and, on the other hand, reducing a stock for 20 minutes in a vessel of a food processor by heating at 98° C. Both steps are performed in an automated and/or supervised manner such that the presence of a user is not required. The control device determines from this information in the case of a simultaneous start of the two steps that a user may be absent for 20 minutes. For example, a threshold of 10 minutes is stored in the control device. Since 20 minutes is above the threshold, the control device informs the user that he or she may be absent. Preferably, the control device then also informs the user about the duration of his possible absence. Thus, in the example given, the user is informed that he or she may be absent for 20 minutes. The information may be provided acoustically via a speaker or optically via a display. Speaker and display may be part of the control device. The user can then leave and still monitor conditions via the mobile device during food preparation. If the monitoring device monitors the temperature in the oven and/or the temperature in the rack of lamb and/or the temperature in the vessel of the food processor, the user can monitor the one or more temperatures despite being absent from the food preparation location. If the monitoring device monitors other one or more conditions, the user can monitor other one or more conditions despite his absence from the food preparation location.

The monitoring device may be a mobile-use food thermometer.

The food thermometer is a temperature measuring device designed and suitable for measuring temperatures in a food during the preparation of the food. The food thermometer can therefore measure temperatures that may occur during the preparation of a food. Significantly deviating temperatures cannot be measured. In addition, the food thermometer can withstand the surrounding conditions that can occur during the preparation of a food.

As a rule, temperatures of less than 220° C. are reached during the preparation of a food. However, temperatures of 350° C. can also be reached, for example for baking a pizza. Temperatures of more than 350° C. are generally not exceeded. The food thermometer in the sense of the present disclosure is therefore configured such that temperatures above 400° C., preferably above 300° C., particularly preferably above 250° C., can no longer be measured. In principle, the food thermometer is configured such that it can be used in a conventional oven, i.e. at temperatures of up to 250° C. or at least up to 220° C.

The food thermometer is not designed to measure very low temperatures, such as temperatures below sub-zero temperatures reached in household freezers. Thus, a food thermometer in the sense of the present disclosure is generally not designed to measure temperatures lower than -70° C. Preferably, a food thermometer in the sense of the present disclosure is designed such that it cannot measure temperatures below -50° C., because food is generally produced with the addition of heat and very low temperatures are only used for freezing a food.

The food thermometer can withstand a steam atmosphere. The food thermometer is therefore basically encapsulated in a waterproof manner. The food thermometer is resistant to common ingredients of a food such as acid of lemons or vinegar.

The food thermometer is physically separated from the other devices of the system. It can therefore be used in a mobile way. The food thermometer can therefore be used in an oven as well as in another vessel of a kitchen appliance to measure temperatures. In an alternative configuration, the monitoring device could be integrated into a food preparation vessel. For example, the food preparation vessel may be a frying pan.

The food thermometer has a radio unit. Due to the radio unit, the food thermometer can communicate with the preferably mobile device and with the control device. For example, Bluetooth Low Energy may be used as a radio technology so that the power consumption of the food thermometer can be kept low. However, Wi-Fi or Ultra Wideband (UWB) is also possible, but this leads to higher power consumption.

The food thermometer preferably has an internal power supply so that it can be easily used in a mobile way.

The food thermometer preferably has two spatially separated temperature sensors. If the food thermometer is inserted into a food, then the temperature prevailing in the food can be measured with one temperature sensor. The other temperature sensor can be used to measure the surrounding temperature. Overall, temperature profiles can be determined more accurately, which can improve the preparation of a food. The distance between the two temperature sensors can be at least 5 cm in order to be able to suitably measure spatially separated temperatures.

To allow the food thermometer to be easily inserted into a food, the food thermometer preferably has a pointed end. Preferably, a temperature sensor is located at the pointed end in order to be able to measure the temperature inside a food. A second temperature sensor is then advantageously arranged in the half of the food thermometer that is away from the tip. The second temperature sensor can then be used to measure a surrounding temperature when the tip has been inserted into a food.

The system may comprise a food processor. The food processor comprises a food preparation vessel that can be inserted into a stand part of the food processor. The stand part can and should enable the food processor to be placed on a base. The food preparation vessel inserted into the stand part can also be removed from the stand part and then used in a mobile manner independent of the stand part. The food processor comprises a mixing and/or chopping tool that can mix and/or chop foodstuffs in the food preparation vessel.

The food processor may comprise a heating device by means of which a foodstuff present in the food preparation vessel can be heated. The heating device is preferably an electrical heating device. For example, the food preparation vessel may comprise electrical heating conductors with which foodstuffs in the food preparation vessel can be electrically heated.

The food processor may comprise a scale for weighing foodstuffs in the food preparation vessel. The food processor may include a touch-sensitive display that can be used to control the food processor. The display may also display conditions that occur during preparation of a food at the food processor or at another kitchen appliance. The food processor may comprise a speaker, for example, to output conditions acoustically. The food processor may comprise a microphone so that input can be made via voice commands.

The food processor preferably comprises a radio unit. The radio unit may comprise Bluetooth Low Energy and/or Ultra Wideband as radio technology. Since the food processor is a stationary device, it can be unproblematically supplied with electrical energy via an external power source. Therefore, it is not necessary to pay attention to a very low power consumption in order to enable long operating times. The food processor can therefore alternatively or additionally comprise Wi-Fi as a radio standard, for example, in order to be able to access electronically stored recipes via the Internet.

The food processor may comprise a thermometer by means of which a temperature in the food preparation vessel can be measured.

The food processor may comprise one or more mechanical control elements. As a mechanical control element, a rotary knob may be present with which, for example, rotational speeds of the then rotatable mixing and/or cutting tool can be set by rotating it. Alternatively or additionally, desired temperatures can be set, which can be reached in the food preparation vessel and maintained under the control of the control device.

The control device can be integrated into the food processor. The control device is generally located in the stand part of the food processor. The number of devices in the system can thus be kept low. Nevertheless, the system is then powerful and allows a large number of preparation options.

A push button can be used as a mechanical control element. Pressing the push button can, for example, start a processing step or confirm an input.

Preferably, a knob is provided that can both be rotated and pressed to keep the number of control elements low for reasons of clarity.

A lid for the food preparation vessel may be provided in order to be able to partially or completely close the food preparation vessel by means of the lid during the preparation of a food. Preferably, the lid can be locked and unlocked manually or in an automated manner. In the locked state, the lid cannot be released from the food preparation vessel.

The system may be configured such that the monitoring device can be exclusively connected to the control device for communication. The monitoring device can then transmit data to the mobile device and/or to another device and/or be connected to the mobile device or another device for communication only when the control device releases (approves) this. It is thus avoided that the preparation of a food can be inadvertently interfered with in an erroneous manner. It is thus ensured that there can be phases of a food preparation in which only a user who is present can intervene in a corrective manner if necessary. A user who is present can reliably judge whether an intervention is required. Even if an intervention is then carried out in error, the user who is present can immediately take corrective measures comprehensively. A user who is not present is not able to do this.

There may be a status indicator at the monitoring device, which controls whether only one connection to a device is allowed. The status indicator can be set during a consisting connection in such a way that a further connection is excluded by it.

There may be a status indicator at the monitoring device, which controls whether the monitoring device is free for controlling the monitoring device.

There may be a charger for the monitoring device. The monitoring device may be configured such that charging a battery of the monitoring device causes one or both status indicators to be set such that the monitoring device is free to connect and/or control.

Preferably, the control device is configured such that it releases the possibility of data transmission or connection between the monitoring device and the preferably mobile device after a possible absence time for a user has been detected by the control device during the controlled preparation of a food. It may be that a user must first confirm this before the release. The confirmation may be done, for example, by operating a control element of the control device. For example, the control device recognizes that a user may be absent for 20 minutes and therefore informs the user that he or she may now be absent. The user then operates a control element of the control device. By operating the control element, the user confirms that he or she wants to make use of the option to be absent. The user thus performs the release by operating the control element. Thereupon, the control device controls the system, usually the monitoring device, in such a way that the monitoring device can connect to the mobile device and/or another device or at least to transmit data to the mobile device and/or another device. Subsequently, the mobile device and/or another device can receive data from the monitoring device. By “receiving data from the monitoring device” is meant that data can be received such that they may be processed by the receiving device. Processing may be that monitored conditions can be optically displayed on the receiving device. Processing may be that monitored conditions can be output acoustically via the receiving device. Processing may be that a connection for communication is established between the monitoring device and the receiving device. Once a connection for communication is established, the receiving device may, for example, receive condition information and/or conditions from the monitoring device and/or request receipt of condition information and/or conditions from the monitoring device.

A control element may be a mechanically operated control element. A control element may be provided by a touch-sensitive display. A control element may be implemented by a voice input.

In one embodiment of the disclosure, the connection between the control device and the monitoring device is terminated when the possibility of data transmission or connection between the monitoring device and the preferably mobile device is released. Thus, it is avoided in an improved manner that a third party, for example, inadvertently operates the control device in the absence of the user in such a way that the preparation of a food is incorrect. For example, a user has confirmed the release by operating a control element of the control device. The control device then terminates the connection between the control device and the monitoring device. The monitoring device is then configured such that termination of the connection between the monitoring device and the control device results in the preferably mobile device being able to connect to the monitoring device. Alternatively or additionally, terminating the connection between the monitoring device and the control device may result in data being sent from the monitoring device that can be received by the preferably mobile device. The sending of data can then take place periodically, for example. For example, data can be sent every two, three or four seconds.

The control device can be configured such that it can control which data the monitoring device transmits. Preferably, the control device is configured such that it controls which data is sent by the monitoring device following a release. This data is also called useful data or payload. In particular, the control device is configured such that it controls the monitoring device such that modified data is sent by the monitoring device following a release compared to before the release. For example, there consists an exclusive connection between the monitoring device and the control device. The monitoring device is configured such that data A and B are transmitted from the monitoring device to the control device, for example, periodically. The control device determines that an absence of the user is possible and informs the user. Subsequently, the user confirms the release by operating a control element of the control device. The control device then controls the monitoring device in such a way that data B and C are now transmitted by the monitoring device. The monitoring device then continues to send B, but also sends other data because of C and thus modified data. The advantage of this embodiment consists in the fact that it is possible to react to changed requirements. For example, it can be useful that the monitoring device transmits the measured temperatures inside a food to the control device (data A) and also the temperatures (data B) measured in the cooking vessel of the corresponding kitchen appliance outside the food. These temperatures can be transmitted to the control device, for example, so that the control device can control the kitchen appliance in a particularly suitable way. If it is finally achieved that the temperature prevailing in the cooking vessel outside the food only has to be kept constant and therefore no control by the control device is required anymore, this may result in the control device informing the user that he or she may be absent. It is now of interest to the user that he or she is informed by the mobile device not only about temperatures, but also about the end of the cooking time. The expected end of the cooking time is known to the control device as it controls the food preparation. The control device therefore controls the monitoring device in such a way that it not only sends the measured temperature (data A and B), but also the time (data C) of the expected end of the cooking time. The expected end of the cooking time has thus been transmitted from the control device to the monitoring device such that the monitoring device then sends the expected end of the cooking time. The control device may thus be configured such that it can transmit information such as the expected end of cooking time to the monitoring device such that the monitoring device subsequently sends or at least can send the information. However, it is also possible that the monitoring device is controlled by the control device in such a way that only temperatures measured outside the food (data B) and the end of the cooking time (data C) are transmitted to the mobile device.

Preferably, the modification in the data sent by the monitoring device causes a reduction in the amount of data. The amount of data before the modification is therefore greater than the amount of data after the reduction. For example, prior to the reduction in the amount of data, a name individually set by the user may have been sent to the monitoring device. This may have been done to make it easier for a user to recognize which monitoring device the control device has connected to. In order to reduce the amount of data due to the modification, the sending of the name can be omitted following the sending. Reducing the amount of data makes it technically easier to implement the change.

The data sent after a modification should comprise at least the measured values of the monitoring device, a time until the end of the absence and status information about the monitoring device. If the monitoring device is a food thermometer with two temperature sensors, then the measured values of the two temperature sensors are sent from the food thermometer.

The control device may be configured such that switching off the control device causes the monitoring device to be controlled by the control device as described above. This ensures that monitoring by a mobile device is still possible after the control device is switched off.

This sending by the monitoring device can be done without having to establish a connection to a mobile device beforehand. In this case, several mobile devices can receive data from the monitoring device simultaneously. This embodiment is particularly useful if data such as temperatures and end of cooking time are only displayed by a mobile device without the food preparation being controlled via the mobile device.

This sending by the monitoring device can only take place after a connection to a mobile device has been established. This embodiment is particularly useful if not only data such as temperatures and end of cooking time can be displayed by a mobile device, but the food preparation or the monitoring device can also be controlled via the mobile device. In this way, it can be ensured that only a mobile device previously authorized by the connection enables control of the food preparation and/or the monitoring device.

Sending data from the monitoring device to one or more mobile devices is preferably done periodically. Thus, the data is transmitted repeatedly, wherein there is a predetermined period of time between a first and a second sending of the data. The predetermined time period can be, for example, 1 second to 10 seconds. 2 to 4 seconds is particularly expedient so that, on the one hand, power consumption can be kept low and, on the other hand, a user does not have to wait too long.

Sending data from the monitoring device can also be done to one or more non-mobile devices. For example, data can be transmitted to a second, non-mobile control device so that the second control device can replace the first control device. An exclusive connection may then be produced between the second control device and the monitoring device, for example. The first control device can then, for example, be part of a food processor that can process foodstuffs by means of a mixing tool and/or cutting tool with high rotational speeds of, for example, at least 5000 or 10000 revolutions per minute. The second control device can then, for example, be part of a stirring device that can process foodstuffs by means of a mixing tool and/or cutting tool only at low speeds of, for example, no more than 1000 or no more than 300 revolutions per minute. A user is then able to switch off a food processor and only continue the preparation with the stirring device when the food processor is no longer needed, but only the stirring device.

However, it is also possible to use two identical non-mobile devices for the preparation of a food, for example two food processors. Another non-mobile device is then also a food processor.

Data that the monitoring device is able to send may comprise conditions that are monitored by the monitoring device. The data may comprise an indication of the time at which a processing step ends. For example, the time may be indicated in terms of minutes and seconds to wait until the end of the processing step. The data may comprise a condition of the monitoring device such as the condition of a battery of the monitoring device. The data may comprise information about the identity of the monitoring device, such as manufacturer information. A receiving device may thus be told which monitoring device it is. The receiving device can then set, for example, what can be displayed by the receiving device and in what way.

The connection between the monitoring device and the control device and/or the connection between the monitoring device and the preferably mobile device may require the input of a key to authorize connections. For example, a key may be printed on the monitoring device in the form of a letter/number code or shown on a display of the monitoring device. For a connection, the key must then be entered at the control device and/or at the preferably mobile device.

In one embodiment, the control device is configured such that it displays a key that must be entered at the preferably mobile device in order for the preferably mobile device to connect to the monitoring device. The control device may have requested this key from the monitoring device and subsequently received it from the monitoring device. The control device may have generated this key randomly, for example, and transmitted it to the monitoring device. By this embodiment, it can be achieved in a further improved manner that only authorized preferably mobile devices can connect to the monitoring device.

It may be sufficient for the key to be entered only once. For example, if a connection between the control device and the monitoring device and/or the preferably mobile device and the monitoring device has been authorized a first time, then a new connection does not require a key to be entered again. It may be that the key requires re-entry of a key for each time a connection is established. It is preferable that a key only needs to be entered once.

It may be that different monitoring devices are present as part of the system. Preferably, there is then only one key for all monitoring devices, so as not to make the connection unnecessarily complicated. It is also possible that a key can be displayed by a program that is installed on the preferably mobile device. These embodiments are based on the realization that a rather simple security standard is sufficient to be able to avoid accidental operating errors. It may be that the program allows to select one in case of several monitoring devices.

The control and/or control device and/or the mobile device may be configured such that they can connect not only to the monitoring device, but also to the kitchen appliance used to prepare a food monitored by the monitoring device. This may enable control of the kitchen appliance by the monitoring device and/or by the preferably mobile device. The degree of automation of a food preparation can thus be further improved.

In a preferred embodiment, the preferably mobile device is configured such that by invoking a program or only after invoking a program installed on the preferably mobile device, conditions can be received from the monitoring device and/or a connection for communication is or can be produced. On the preferably mobile device thus a program may have been installed, which can be invoked. Through the program, further possibilities may then advantageously be available which support the preparation of the food.

It may be, for example, that data transmitted by the monitoring device are only displayed by the preferably mobile device on the basis of the program. It may be that due to the program a running processing step of the food preparation can be controlled. It may be that due to the program the monitoring device can be allowed to transmit data to further devices. The preparation of a food can thus be further facilitated in an improved manner.

The preferably mobile device may be configured such that it alerts the user, for example acoustically via a speaker and/or optically via a display, if a monitored temperature and/or condition exceeds a predetermined threshold and/or falls below a predetermined threshold. This facilitates the possibility of absence in a further improved manner. The speaker and/or the display may be part of the preferably mobile device.

The kitchen appliance by means of which the food is prepared may have an integrated thermometer. The integrated thermometer can be used, for example, to measure temperatures in a cooking vessel or cooking chamber of the kitchen appliance. The kitchen appliance may have a kitchen appliance control device to control, for example, temperatures in the cooking vessel or cooking chamber of the kitchen appliance without having to use the control device.

The monitoring device, the control device and/or the preferably mobile device may each comprise a radio unit to be able to wirelessly transmit and/or receive data. Preferably, the monitoring device, the control device and the preferably mobile device communicate wirelessly with each other.

According to the present disclosure, kitchen appliances with a heating device such as an oven or pizza oven, microwave oven, steamer, hob with cooking vessel, food processor or grill can be used to supply heat to a food for a preparation.

Control device, mobile and/or non-mobile device, kitchen appliance and monitoring device are independent of each other, i.e. not physically connected.

The system may comprise more than one mobile device, a kitchen appliance and/or a monitoring device.

The monitoring device is preferably a food thermometer with a tip and with two temperature sensors. One temperature sensor is located at the tip of the food thermometer. The other temperature sensor has a distance to the tip. This distance to the tip is in particular at least 5 cm, so that the temperature inside a food and outside a food can be measured.

The present disclosure also relates to a control device configured as previously described. The disclosure also relates to a monitoring device configured as previously described. The disclosure also relates to a mobile device configured as previously described.

The present disclosure relates to a method for the preparation of a food using the system described above. At the beginning of a preparation of a food, the monitoring device is exclusively connected to the control device for communication in such a way that the monitoring device then cannot be connected to the mobile device for communication. It is thus avoided that the system can be influenced by a mobile device already at the beginning of a food preparation in an uncontrolled, for example accidental manner. The connection can be made in an automated manner as soon as the control device and monitoring device have been switched on.

1. A system for the preparation of a food, the system comprising
a monitoring device for monitoring the food during its preparation,
a control device for the preparation of the food by means of a kitchen appliance and by means of an electronically stored recipe, and
at least one of a mobile device and a non-mobile device,
wherein the monitoring device is able to communicate with the control device and the mobile device and/or with the non-mobile device, and wherein the mobile device and/or a non-mobile device are configured such that it is able to transmit information of the monitoring device to a user.

2. The system of claim 1, wherein the control device is configured such that during the controlled preparation of a food it recognizes possible absence times for a user and informs the user about it.

3. The system of claim 1, wherein the monitoring device is a mobile-use food thermometer with a radio unit.

4. The system of claim 1, further comprising a food processor and the control device is integrated in the food processor, wherein the food processor comprises a food preparation vessel which can be inserted in a stand part of the food processor, and a mixing and/or chopping tool which can mix and/or chop foods present in the food preparation vessel.

5. The system of claim 1, wherein the system is configured such that the monitoring device is exclusively connected to the control device for communication in such a way that the monitoring device is connected to the mobile device and/or to the non-mobile device for communication when the control device releases this.

6. The system of claim 5, wherein the control device is configured such that it enables the mobile device and/or the non-mobile device to connect to the monitoring device for communication in response to one of the control device has detected a possible absence time for a user during the controlled preparation of a food, or the control device has detected a possible absence time for a user during the controlled preparation of a food and the user has confirmed a release by operating a control element of the control device, or when the control device is turned off.

7. The system of claim 6, wherein the system is configured such that the connection between the control device and the monitoring device is terminated in response to one of (A) the possibility is released that the monitoring device can connect to the mobile device and/or to the non-mobile device and(B) that the monitoring device can transmit data to the mobile device and/or to the non-mobile device.

8. The system of claim 1, wherein the control device is configured such that it is able to control which data the monitoring device transmits.

9. The system of claim 8, wherein the control device is configured such that it can transmit information to the monitoring device in such a way that the monitoring device subsequently sends the information.

10. The system of claim 1, wherein the monitoring device is able to send one or more of the following data:
one or more conditions monitored by the monitoring device;
indication of a time until completion of a processing step;
one or more conditions of the monitoring device.

11. The system of claim 1, wherein a connection between the monitoring device and the mobile device and/or the non-mobile device requires the input of a key which is at least one of displayed by the control device andsent by the monitoring device.

12. A food thermometer, the thermometer configured such that it is able to communicate wirelessly with a control device and at least one of a mobile and non-mobile device, and configured such that it can receive data from the control device which can subsequently be sent from the food thermometer to the mobile and/or non-mobile device.

13. The food thermometer of claim 12, the thermometer having a tip and two temperature sensors, wherein one temperature sensor is located at the tip and the other temperature sensor is spaced apart from the tip.

14. The food thermometer of claim 13, wherein the other temperature sensor is spaced at a distance of at least 5 cm from the temperature sensor at the tip.

15. The food thermometer of claim 12, further comprising a radio unit with Bluetooth.

16. The system of claim 5, wherein the control device is configured such that the mobile device and/or the non-mobile device is able to receive data from the monitoring device in response to one of the control device has detected a possible absence time for a user during the controlled preparation of a food, or the control device has detected a possible absence time for a user during the controlled preparation of a food and the user has confirmed a release by operating a control element of the control device, or when the control device is turned off.

17. The system of claim 16, wherein the system is configured such that the connection between the control device and the monitoring device is terminated in response to one of (A) the possibility is released that the monitoring device can connect to the mobile device and/or to the non-mobile device and(B) that the monitoring device can transmit data to the mobile device and/or to the non-mobile device.

18. A method for the preparation of a food using a system according to claim 1, the method characterized in that at the beginning of a preparation of a food the monitoring device is exclusively connected to the control device for communication in such a way that the monitoring device then cannot be connected to the mobile and/or non-mobile device for communication.
